(19) United States
(12) Patent Application Publication
(10) Pub. No.: US 2014/0076441 A1
(43) Pub. Date: Mar. 20, 2014

(54) CHOCK DRAIN CONNECTOR

(71) Applicant: SIEMENS INDUSTRY, INC., Alpharetta, GA (US)

(72) Inventors: Peter N. Osgood, Westborough, MA (US); Mortimer Daniel Williams, Sturbridge, MA (US)

(73) Assignee: SIEMENS INDUSTRY, INC., Alpharetta, GA (US)

(21) Appl. No.: 13/622,801

(22) Filed: Sep. 19, 2012

(51) Int. Cl. F16L 37/12; F16L 37/46; F16L 41/08

(52) U.S. Cl. 137/798; 285/136.1

(57) ABSTRACT

A connector attaches a hose to a port from which oil is drained from the chock of an oil film bearing. The connector comprises a conduit having a first leg adapted to be connected to the chock in communication with the port, and a second leg adapted to be connected to the hose. A latching mechanism coacts with the first leg to releasably secure the conduit to the chock.

### BACKGROUND

1. Field

Embodiments of the present invention relate generally to oil film bearings employed in various types of industrial equipment, including for example the roll stands of rolling mills, and are concerned in particular with an improved connector for detachably connecting oil drainage hoses to the chocks of such bearings.

2. Description of Related Art

In a rolling mill, rolls and their associated chock assemblies are changed frequently. In the course of doing so, oil supply piping and drainage hoses must be removed from and then re-connected to the bearing chocks. When using conventional hose connections, these tasks are often unduly tabor intensive and time consuming. Additionally, residual oil in the chocks has a tendency to drip out of open drainage ports as the chocks are moved around the mill.

### SUMMARY

Broadly stated, embodiments of the present invention address the above described problems by providing an improved chock drain connector with a latching mechanism designed to facilitate rapid and efficient removal and re-connection of chock drain hoses.

In exemplary embodiments, the chock drain connector comprises a conduit with first and second legs adapted to be connected respectively to the bearing chock in communication with an oil drainage port, and to a drainage hose, with the first leg of the conduit being externally configured to coact with a latching mechanism carried by the chock and serving to releasably secure the conduit to the chock.

In exemplary embodiments, the drain connector may be elbow-shaped, with a first leg projecting horizontally into the chock drainage port, and with a second leg extending downwardly at an angle from the first leg.

The latching mechanism may comprise an external groove on the first leg, and a wheel with a circular rim interrupted by a notched segment. The wheel is carried by an adaptor plate fixed with respect to the chock, and is rotatable between a locked position at which its circular rim projects into the external groove to secure the drain connector to the chock, and an unlocked position at which the notched segment is aligned with the external groove to accommodate removal of the drain connector from the chock.

In one exemplary embodiment, the drain connector may further comprise a gate valve mechanically coupled to and adjustable in concert with the latching mechanism between a closed position preventing oil from escaping from the chock drainage port when the latching mechanism is unlocked and the drain connector is removed from the chock, and an open position permitting flow through the chock drainage port when the latching mechanism is locked and the drain connector is connected to the chock.

The gate valve may comprise an integral component of an adaptor secured to the exterior of the chock, or, alternatively, it may be located internally within the chock.

These and other objects, features and advantages of the present invention will become more apparent upon reading the following detailed description in conjunction with the accompanying drawings.

### BRIEF DESCRIPTION OF THE DRAWINGS

FIG. 1 is a front view of an oil film bearing with hoses attached to its drainage ports by connectors in accordance with first and second exemplary embodiments of the present invention;

FIG. 2 is a sectional view on an enlarged scale of the first exemplary embodiment of the present invention taken along line 2-2 of FIG. 1;

FIG. 3 is an external view of the first exemplary embodiment of the present invention, with the latching mechanism engaged and the connector conduit coupled to the chock drainage port;

FIG. 4 is an internal view of the first exemplary embodiment of the present invention, with the slidable gate valve open;

FIG. 5 is an external view of the first exemplary embodiment of the present invention, with the latching member disengaged and the connector conduit uncoupled from the chock drainage port;

FIG. 6 is an internal view of the first exemplary embodiment of the present invention, with the slidable gate valve closed;

FIG. 7 is a sectional view on an enlarged scale of the second exemplary embodiment of the present invention, taken along line 7-7 of FIG. 1;

FIG. 8 is an internal view of the second exemplary embodiment of the present invention, with the rotatable gate valve open;

FIG. 9 is an external view of the second exemplary embodiment of the present invention, with the latching member disengaged and the connector conduit uncoupled from the chock drainage port;

FIG. 10 is an internal view of the second exemplary embodiment of the present invention, with the rotatable gate valve closed; and

FIG. 11 is an enlarged view of the circled portion shown in FIG. 7.

### DETAILED DESCRIPTION

The components described hereinafter as making up the various embodiments are intended to be illustrative and not restrictive. Many suitable components that would perform the same or a similar function as well as the materials described herein are intended to be embraced within the scope of embodiments of the present invention.

Referring now to the figures, wherein like reference numerals represent like parts throughout the view, embodiments of the present invention will he described in detail.

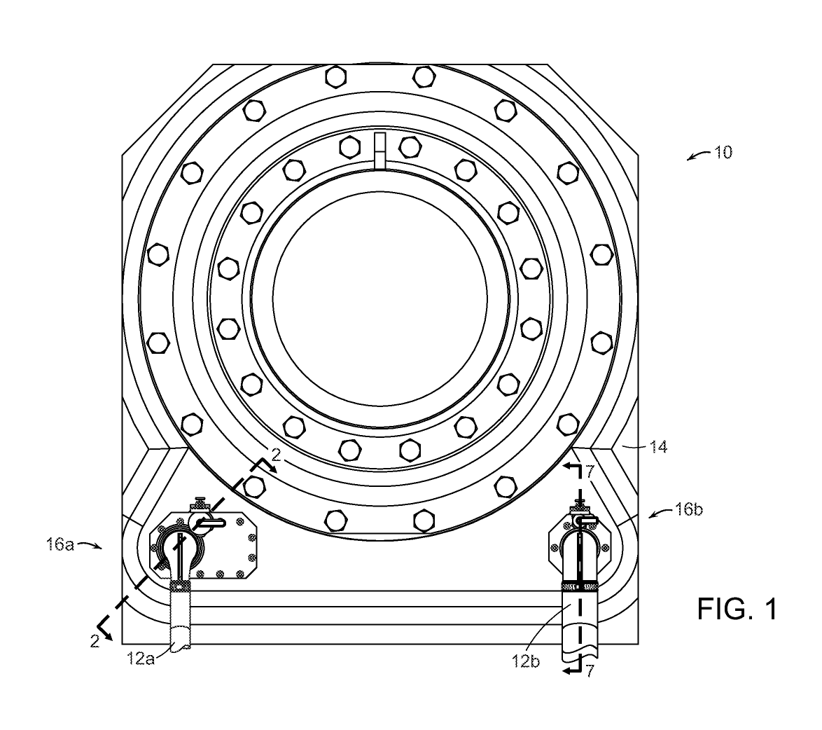

With reference initially to FIG. 1, an oil film bearing is generally depicted at 10. Hoses 12a, 12b are connected to oil drainage ports of the bearing chock 14 by first and second connectors 16a, 16b in accordance with exemplary embodiments of the present invention.

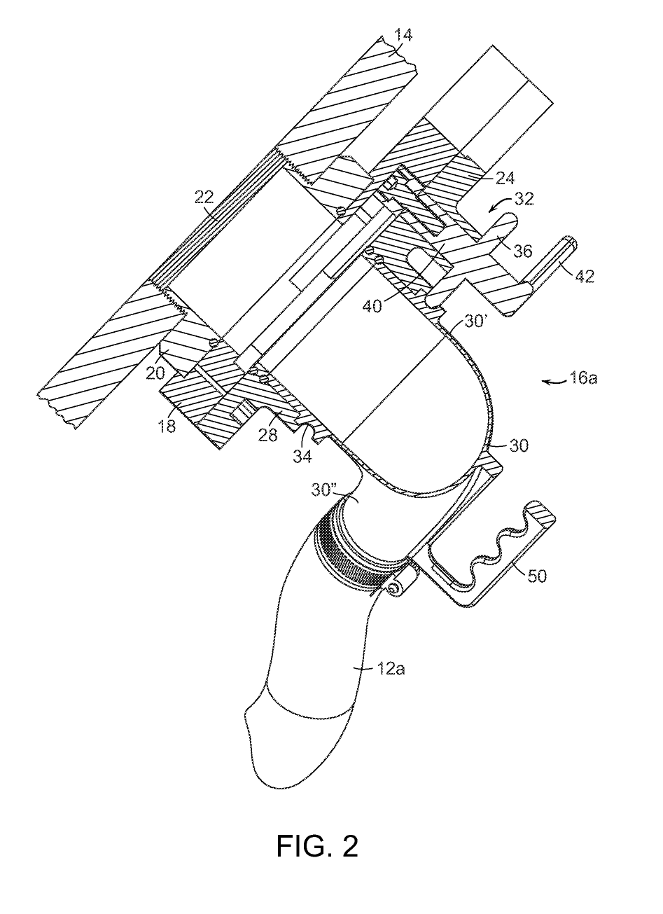

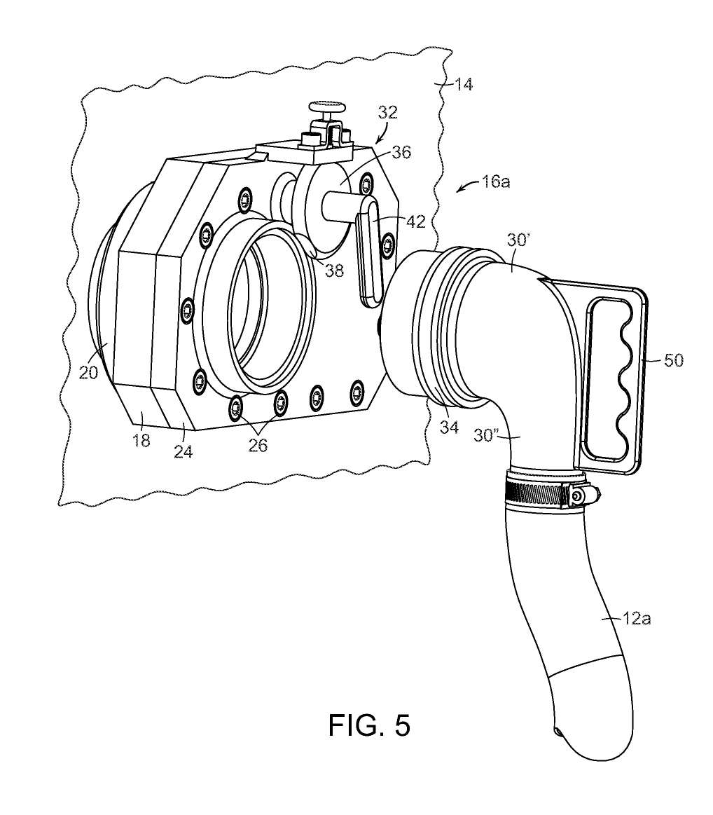

With reference additionally to FIGS. 2-6, connector 16a comprises an adaptor plate 18 with a nipple 20 threaded into one of the chock drainage ports 22. A face plate 24 is secured to the adaptor plate by fasteners indicated typically at 26. The adaptor plate 18 and face plate 24 have aligned openings defining a through passage communicating with the chock drainage port 22 via nipple 20.

An external collar 28 surrounds the opening in face plate 24.

An elbow-shaped conduit 30 has a first leg 30′ adapted to protrude into collar 28, and a second leg 30″ adapted to be connected to the hose 12a. The second leg 30″ is angled downwardly with respect to the first leg 30′, typically although not necessarily at 90°. The legs 30′, 30″ may be of the same size, or, as shown in FIGS. 1-6, the second leg 30″ may be of a reduced size in order to accommodate smaller diameter hoses.

A latching mechanism 32 is provided on the face plate 24. The first leg 30′ may be provided with an external circular groove 34, and the latching mechanism may comprise a wheel 36 having a circular rim interrupted by a notched segment 38.

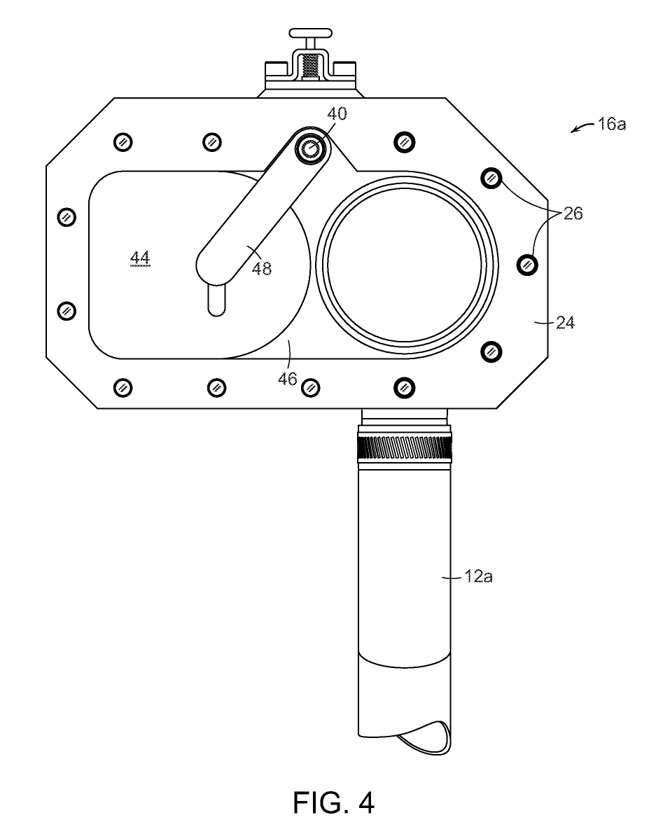

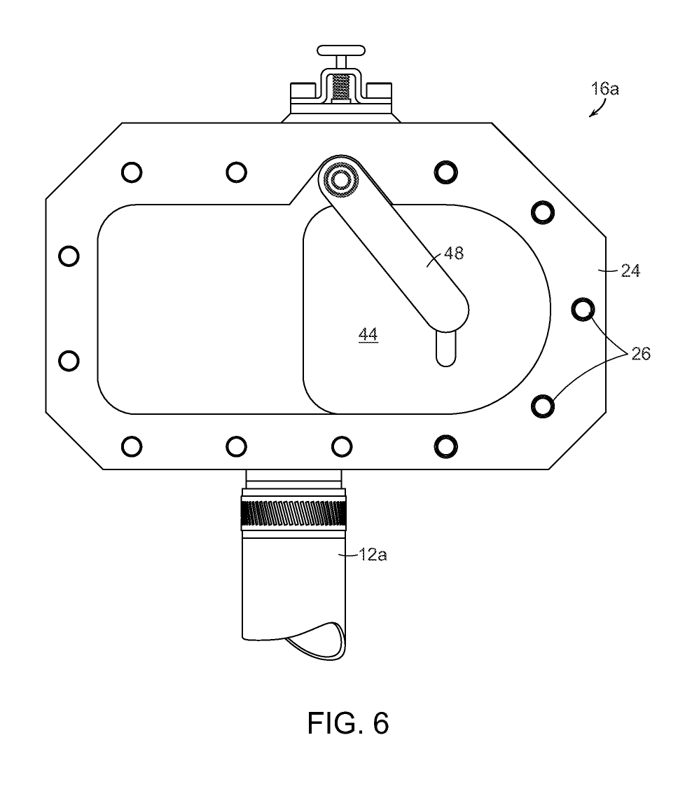

The wheel 36 may be supported on a shaft 40 manually rotatable by an externally accessible handle 42. As can best be seen in FIGS. 4 and 6, a gate valve comprising a slide plate 44 is positioned in a pocket 46 between the adaptor plate 18 and face plate 24. The slide plate 44 is mechanically coupled to shaft 40 by a link 48.

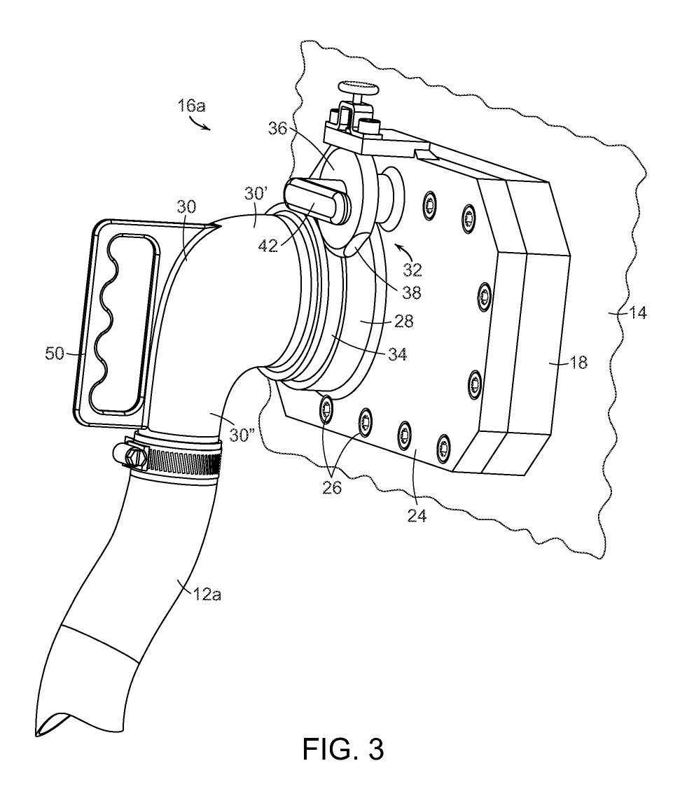

As shown in FIGS. 2 and 3, the conduit 30 is releasably secured in communication with the drainage port 22 of the chock 14 by rotating the shaft 40 to project the rim of the latch wheel 36 into interlocked engagement with the external groove 34 on leg 30′. This rotational adjustment of shaft 40 also acts through link 48 to shift the slide plate 44 to one side of the flow passage defined by the aligned openings in the adaptor plate 18 and face plate 24, thus allowing oil to flow from the chock drainage port 22 through conduit 30 into hose 12a.

In order to disconnect the hose 12a from the chock drainage port 22, the shaft 40 is rotated to align the notched rim segment 38 of wheel 36 with the external groove 34 in the conduit leg 30′, thus freeing the conduit leg 30′ for withdrawal from the collar 28. This rotational shaft adjustment also acts through link 48 to shift the slide plate 44 into the position shown in FIG. 6, closing the flow passage defined by the aligned openings in the adaptor plate 18 and face plate 24 and preventing any leakage of oil from the chock drainage port 22 after the conduit has been uncoupled. An external handle 50 on the conduit 30 facilitates handling of the connector 16a by mill personnel.

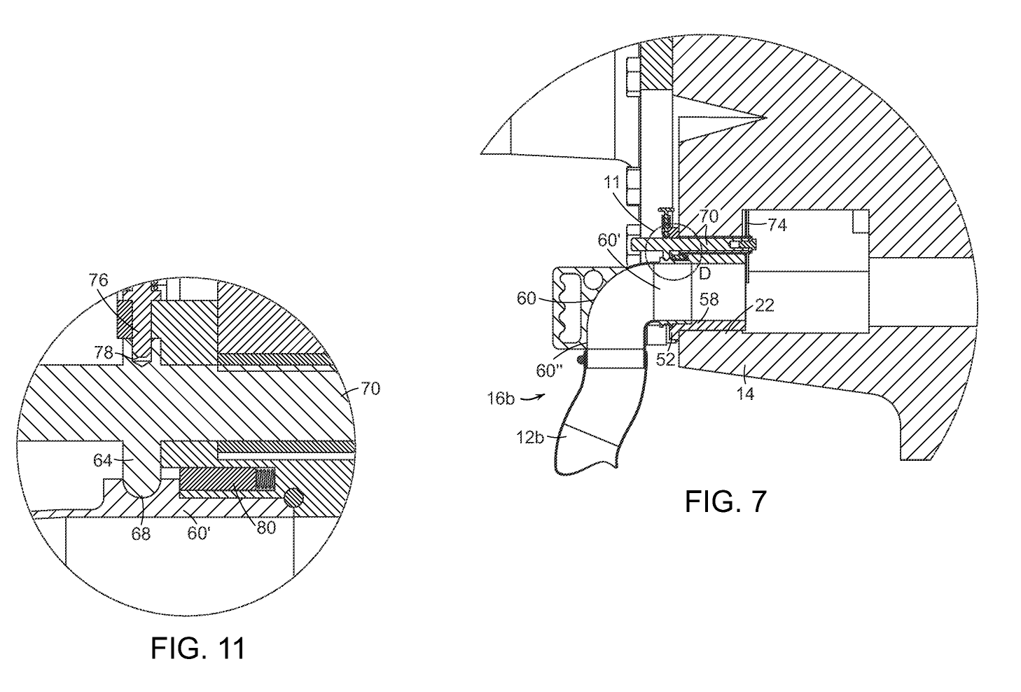

With reference to FIGS. 7-11, the connector 16b in accordance with the second exemplary embodiment of the present invention comprises a face plate 52 attached directly to the chock 14 by fasteners indicated typically at 54. An opening 56 in the face plate 52 (see FIG. 9) is aligned with a tubular nipple 58 projecting from the face plate through the other chock drainage port 22 and into the chock interior.

An elbow-shaped conduit 60 has a first leg 60′ configured and dimensioned to project into the opening 56 in the face plate 52, and a second downwardly angled leg 60″ adapted to be connected to a drainage hose 12b. As with the first exemplary embodiment 16a, and as can best be seen in FIG. 9, the face plate 52 of the second exemplary embodiment 16b is equipped with a latching mechanism 62 comprising a wheel 64 having a circular rim interrupted by a notched segment 66. The latching mechanism 62 coacts in releasable interlocked engagement with an external circular groove 68 on the first conduit leg 60′.

The wheel 64 is carried on a shaft 70 having an external handle 72. Shaft 70 projects through the face plate 52 into the chock interior. A gate valve comprising a circular disc 74 is carried on the inner end of shaft 70.

The conduit 60 is releasable secured in communication with the chock drainage port 22 by rotating the shaft 70 to project the rim of wheel 64 into the external groove 68 on conduit leg 60′. This rotational adjustment of the shaft 70 also serves to rotate the valve disc 74 away from the interiorly projecting end of nipple 58, thus allowing oil to drain through conduit 60 into hose 12b.

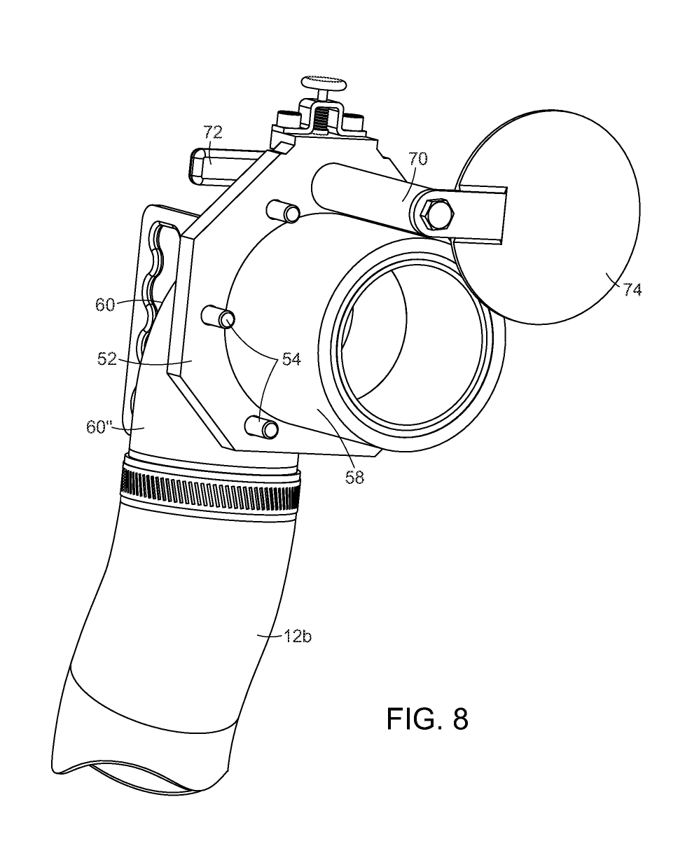

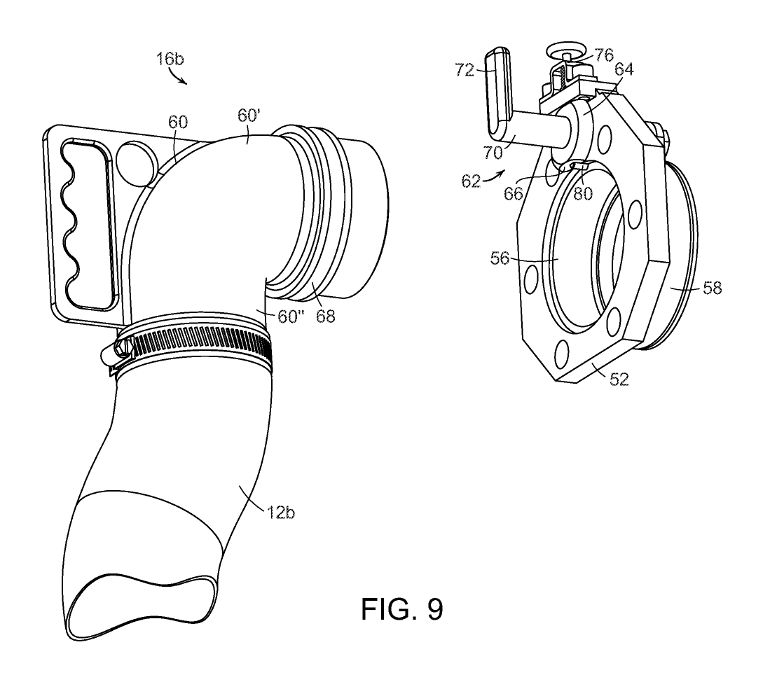

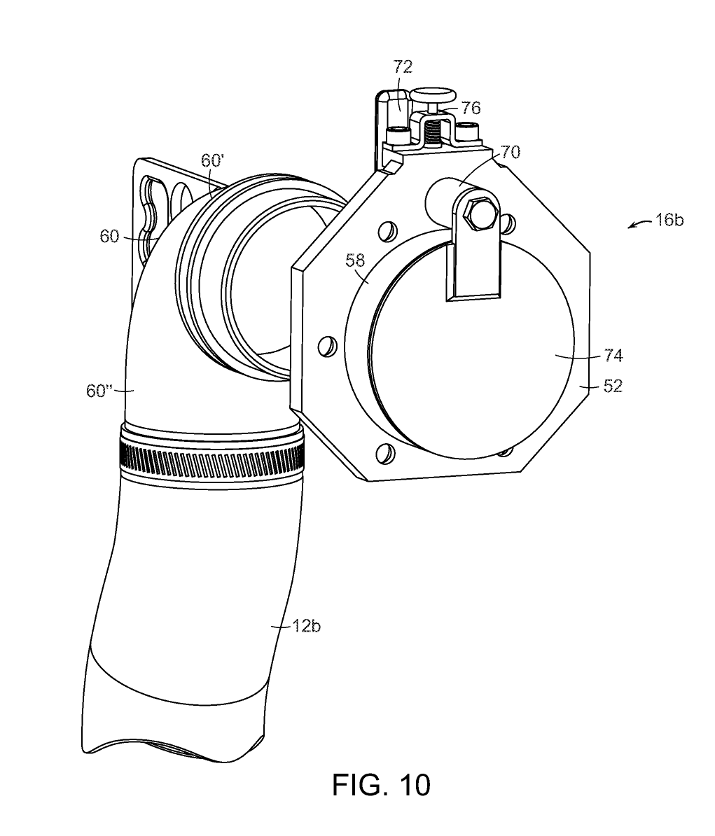

When disconnecting the hose 12b from the chock drainage port 22, the wheel 64 is rotated to align its notched segment 66 with the groove 68 in conduit leg 60′. This rotational adjustment also serves to rotate the valve disc 74 into the position shown in FIG. 10, closing the interiorly projecting end of nipple 58 and preventing any leakage of oil from the chock drainage port 22 after the conduit 60 has been uncoupled from the chock 14.

A manually retractable spring loaded pin 76 may be arranged to coact with a radial hole 78 in the rim of wheel 64 to releasably hold the wheel in its locked position. Additionally, a second spring loaded pin 80 may be provided to coact with the notched segment 66 of the wheel 64 to retain the wheel in its unlocked position. FIG. 9 shows the pin 80 coacting with notch 66, and FIG. 11 shows the pin resiliently retracted out of the plane of wheel 64 by contact with a shoulder on conduit leg 60′ when the conduit leg is inserted into the opening 56 in face plate 52.

While exemplary embodiments of the invention have been disclosed, modification, additions and deletions can be made without departing from the spirit and scope of the invention and its equivalents, as set forth in the following claims.

What is claimed is:

1. A connector for attaching a hose to a port from which oil is drained from the chock of an oil film bearing, said connector comprising:
a conduit having a first leg adapted to he connected to said chock in communication with said port, and a second leg adapted to be connected to said hose; and
a latching mechanism coacting with said first leg to releasably secure said conduit to said chock.

2. The connector of claim 1 wherein said conduit is elbow-shaped, with said first leg extending horizontally into said port, and with said second leg extending downwardly at an angle with respect to said first leg.

3. The connector of claim 1 wherein said latching mechanism comprises an external groove on said first leg, and a wheel having a circular rim interrupted by a notched segment, said wheel being rotatable between a locked position at which said circular rim projects into said external groove to secure said conduit to said chock, and an unlocked position at which said notched segment is aligned with said external groove to accommodate removal of said conduit from said chock.

4. The connector of claim 3 further comprising a gate valve mechanically coupled to and adjustable by said latching mechanism between a closed position preventing flow of oil from said port when said latching mechanism is in said unlocked position, and an open position permitting such flow when said latching mechanism is in said locked position.

5. The connector of claim 4 where said gate valve is slidably manipulated between said open and closed positions.

6. The connector of claim 4 wherein said gate valve is rotatably manipulated between said open and closed positions.

7. The connector of claim 4 wherein said gate valve and said latching mechanism comprise components of an adaptor secured to the exterior of said chock at a position communicating with said port.

8. The connector of claim 4 wherein said gate valve is contained in said chock and said latching mechanism comprises a component of an adaptor secured to he exterior of said chock at a position communicating with said port.

9. The connector of claim 2 wherein said second leg extends at 90° with respect to said first leg.

10. The connector of claim 1 wherein said second leg has a reduced size as compared to the size of said first leg.

11. The connector of claim 1 wherein said first and second legs are of the same size.

12. The connector of claim 3 further comprising resilient means for releasably retaining said wheel in said locked position.

13. A connector for attaching a hose to a port from which oil is drained from the chock of an oil film bearing, said connector comprising:
an elbow-shaped conduit having a first leg adapted to be connected to said chock in communication with said port, and an angled second leg adapted to be connected to said hose;
a latching mechanism for releasably securing said conduit to said chock; and
a gate valve mechanically coupled to and adjustable by said latching mechanism between a closed position preventing flow of oil from said port when said latching mechanism is in said unlocked position, and an open position permitting such flow when said latching mechanism is in said locked position.

14. The connector of claim 13 wherein said gate valve and said latching mechanism comprise components of an adaptor secured to the exterior of said chock at a position communicating with said port, and wherein said gate valve is slidably manipulated between said open and closed positions.

15. The connector of claim 13 wherein said latching mechanism comprises a component of an adaptor secured to the exterior of said chock at a position communicating with said port, and wherein said gate valve is contained in said chock and rotatably manipulated between said open and closed positions.
